(19) United States
(12) Patent Application Publication
(10) Pub. No.: US 2015/0365467 A1
(43) Pub. Date: Dec. 17, 2015

(54) Emulating Functionality for Constrained Devices

(71) Applicants: KONINKLIJKE KPN N.V., The Hague (NL); IMINDS, Gent (BE); UNIVERSITY GENT, Gent (BE)

(72) Inventors: Jeroen Hoebeke, Sint-Denijs-Westrem (BE); Floris Van Den Abeele, Sint-Martens-Latem (BE)

(21) Appl. No.: 14/655,521

(22) PCT Filed: Dec. 27, 2013
(86) PCT No.: PCT/EP2013/078052

§ 371 Date: Jun. 25, 2015

(30) Foreign Application Priority Data
Dec. 28, 2012 (EP) 12199570.8

(51) Int. Cl. H04L 29/08

(52) U.S. Cl. CPC H04L 67/08; H04L 67/12

(57) ABSTRACT

To alleviate constrained nodes (102a-e) from implementing a functionality, a functionality is emulated by an intermediary node (110) for the constrained nodes (102a-e). The intermediary node is configured to intercept requests and process the requests on behalf of the node to fulfill a functionality. The functionality is typically not supported by the constrained node (102a-e). The support for the functionality is added to resource discovery responses, resource announcement messages, and/or resource registration messages to indicate to a client or a resource directory that the emulated functionality is supported by the node.

### FIELD OF INVENTION

The disclosure generally relates to the field of constrained nodes accessible over a network. In particular, though not necessarily, the disclosure relates to methods, systems, an intermediary node and a computer program product for emulating functionality for said constrained nodes.

### BACKGROUND

Devices, such as constrained devices, sensors and actuators, deployed as a network of nodes have become useful for collecting and/or processing data in applications such as ambient intelligence, smart environments, and autonomous control. For example, networked sensors may be deployed in a building to measure the temperature and the humidity such that an air conditioning system for the building may be adjusted autonomously. These networked nodes are generally referred to as constrained nodes or constrained devices in a (constrained) network, and each constrained node generally has at least one resource such as temperature or humidity. The nodes may be accessible, e.g., in an Internet-like network, where each node is a uniquely identifiable node, and the nodes act as servers to which clients can connect. Such a system of nodes may be referred to colloquially as “Internet of Things”. The nodes may be in a wired network and/or a wireless network. Typically, each of the nodes has at least one resource. A resource may be associated with a state of the node and/or information associated with the node, or with an action that can be executed on the node. Examples of resource include “/temperature”, “/humidity”, “/room_location”, “/picture”, “/light_control”, etc. Clients may query the node for the resource at the node.

These networked nodes are typically constrained in their functionality and computational resources. For example, the size of the memory on the node may be limited. The functionality or functionalities implemented on the memory of the node (e.g., the node's capabilities) may also be limited. Furthermore, the node may be relatively low-powered. For instance, some nodes may have a mains power source, while others are battery powered or harvest energy from the environment. The lifetime of the battery restricts the amount of computational power the node may be able to consume at any given time or period. Furthermore, the radio for wireless communication typically consumes most of the energy budget available on the battery of the node. Thus, the number of transmissions over the network is constrained. In some cases, the processor of the node is also limited in its computational power and/or capabilities. In some situations, the network of these nodes may have high loss rates. Various constraints on these nodes make the nodes themselves not ideal for implementing functionalities that are more complex.

In such a network, the nodes may be heterogeneous with varying capabilities, e.g., due to the varying computational and/or power constraints imposed on these nodes, and/or due to varying implementations on nodes from different vendors. In one instance, the nodes may implement the same standards (i.e., the nodes are interoperable), but the nodes do not implement the exact same set of features of a particular standard. Some of the nodes are not capable or suitable to perform more complex functionalities. However, an application collecting data from these nodes may prefer or expect that the plurality of nodes all have the same set of capabilities, because it is often easier to manage a homogeneous set of nodes.

Even if a node has sufficient resources to extend its functionality or to implement the more complex functionalities, it may not be practical, efficient, or feasible to update the node. In one instance, updating a node is not practical because an update may require replacing the entire firmware installed on the node (including, e.g., entire network stack, applications, radio driver, etc.). In another instance, replacing the entire firmware on the node requires a significant amount of data to be transmitted, an amount many times greater than the amount of data transmitted during normal operation. The data transfer imposes a burden on the constrained node, e.g., by consuming a large amount of the available energy budget. In yet another instance, updating a node is not feasible if a node is a device managed by company A, but used by multiple stakeholders. The stakeholders would like to interact with the node, but company A does not want to allow all the stakeholders to make updates to the node. Furthermore, the node may simply not be able to accommodate all the functionalities pushed by the stakeholders. In yet another instance, the updating procedure for these nodes may temporarily disrupt the operation of these nodes. The method to ensure successful updates of these nodes may be cumbersome and complex, especially if a large number of nodes are to be updated.

One possible way of providing more complex functionality for applications utilizing these constrained nodes is to offer a database, which collects data from these constrained nodes. Using such a database, an application can query the database to derive information to fulfill more complex functionality on the data. However, such a solution does not allow the application to directly interact/interface with the nodes themselves. Any, albeit more complex, functionality is limited to what the database gathers, and the application lacks the freedom or flexibility to implement functionalities at the node level. Furthermore, the logic of designing services based on direct interactions with the nodes is lost (and is replaced by logic for querying the database and its application programming interface), thus undesirably breaking the direct interaction with the nodes themselves.

### SUMMARY

To alleviate some of the problems described above, a method, performable by an intermediary node in a network, for emulating a functionality for a node communicably connected to the network is disclosed. Emulating a functionality for a node enables the imitation of a functionality for the node by fulfilling the functionality at the intermediary node rather than at the node itself. The functionality is thus performed on behalf of the node. Emulation is particularly advantageous when the functionality is not supported by the node, cannot be accommodated by the node due to its constraints (e.g., storing and providing a picture), or is not efficient or practical at the time to be carried out by the node, thus alleviating the problems described herein. Such a method enables the intermediary node, preferably having more power and/or computational resources than the node, to fulfill a functionality on behalf of the node so that the capabilities and/or resources of the node (i.e., left unchanged) may be augmented with modified capabilities and/or resources. In some cases, computational resources and/or energy budget of the node may be made more efficient through emulation.

A node may include a device such as a sensor, an actuator, etc. Typically, the node may include a constrained device. A node may have at least one resource. In some embodiments, a resource may have information associated with that node and/or has a state associated with that node. In some embodiments, a resource may be associated with an action that can be executed on the node A node having different measuring sensors such as a temperature sensor and a humidity sensor may be considered a node with resources including “/temperature” and “/humidity”. A battery-powered node may be considered a node with a resource “/battery_level” or any suitable resource for revealing the node's battery level. A node capable of switching on or off the light may be considered as a node with a resource “/light_control”. A node located at a particular room in a building may be considered a node with a resource “/room_number” or any suitable resource that reveals information associated with the node. A node may be configured with certain capabilities, which may enable a node to respond to certain types of client requests and/or perform certain functionalities.

A method for performing a functionality on behalf of a node communicably connected to a network is disclosed. Generally, the node acts as a server for one or more client. The method is preferably performed by an intermediary node communicably connected to the network. At the intermediary node, a first request from a client transmitted over the network is intercepted. The first request is intended or destined for the node. Typically, but not always, the first request has a destination address which comprises an address of the node.

The intermediary node then checks whether the first request is associated with the functionality to be emulated by the intermediary node for the node. If the first request is associated with the functionality to be emulated by the intermediary node, the intermediary node processes the first request in accordance with said functionality to derive a first response. The first response is then transmitted from the intermediary node to the client over the network. Typically, but not always, said first response sent by the intermediary node may appear to have originated from the node itself. For instance, the first response may have a source address comprising the address of the node. The client thus may not be aware or have any information, which indicates that the functionality has been performed at least in part by the intermediary and not the node itself. As a result, the functionality has been emulated by the intermediary node.

Advantageously, the functionality being emulated is performed by the intermediary node to alleviate the burden of having the functionality implemented at the node itself. Furthermore, the request destined to the node is intercepted and the response is transmitted as if the response had originated from the node. Advantageously, the intermediary node imitates the functionality of being able to directly interact with the node, and the client is unaware that the intermediary node had performed the functionality. As a result, the functionality of the node is augmented or enriched by the intermediary.

In the context of this disclosure, a functionality is defined to be a useful function within a computer application or program, the resource and/or capacity of a computer program or application to provide a useful function. Examples of emulated functionalities may include at least one of: providing a resource and/or a capability of a node, providing access control to a resource and/or a capability of a node, augmenting responses originated from a node with additional useful information, filtering responses originated from a node to hide a part of the response, processing and deriving modified responses from responses originated from a node, and processing a plurality of responses from a node to derive useful information, etc.

For instance, the first request may be associated with a plurality of requests to the node to fulfill the functionality, and the responses from the node are then processed to derive a suitable response to the first request. An example is an “observe” request configured to transmit a series of “get” requests to poll a node. The functionality emulator then transmits a second request over the network to the node to fulfill at least a first part of said functionality. Upon receiving a first response to the second request from the node over the network, the functionality emulator derives a second response to the first request by processing said first response in accordance with said functionality. The derivation step preferably fulfills the functionality that the node is not readily capable or suitable of performing. Accordingly, the functionality emulator provides added functionality through the emulation, without requiring the node to support the functionality. The emulator then transmits the second response to the client over the network.

According to one aspect, the functionality to be emulated by the intermediary node is not supported by the node or the functionality is not suitable to be performed by the node. For instance, the functionality is too big to fit in the memory of the node, or the functionality could fit but would lead to an increase in the transmitted data and thus energy consumption in the network. The burden of having to implement the functionality on the node is alleviated by the intermediary node, thus in some cases providing savings in resources (on the constrained node). If homogeneity is expected from a large number of nodes, the ability to emulate functionalities for nodes that do not support those functionalities provides an added advantage of making it easier for clients to run (user) applications which expects all the nodes to be able to perform certain functions. Furthermore, conventional methods may elect to implement logic to perform the functionality at a user application rather than at an intermediary node. Emulation is a superior solution because emulation preserves the user application's ability and flexibility to directly interact with the nodes. Furthermore, emulation results in a clean separation of concerns regarding node functionalities versus user application logic. Moreover, the emulated functionality may be made available to more than one user application.

According to one aspect, the intermediary node intercepts requests and makes a determination whether the requests are associated with functionalities to be emulated. Accordingly, if the first request is not associated with the functionality to be emulated, the first request is simply forwarded to the node. Such feature enables the interaction with the node to be transparent, resulting in a similar client-server interaction as if the intermediary node was not present.

According to one aspect, the first request requests for a resource that does not exist on the node. Resources may provide information that describes the node or provides information regarding a state of a resource on the node. Some constrained nodes may not be suitable for providing extra resources, or an intermediary node may elect to provide extra resources to enrich the set of resource(s) offered by the node. Processing the first request by the intermediary node comprises retrieving the resource at a storage of the intermediary node. Accordingly, a first response to provide the resource is generated locally by the intermediary node and the first response comprising the retrieved resource is provided to the client. For the client, being unaware of the intermediary node, the emulated resource appears to reside on the node or provided by the node.

According to one aspect, the first request requests for a resource, whose access may be controlled based on the identity of the client which requested the resource. Alternatively or additionally, the access to the resource may be controlled based on time (e.g., only during office hours). In some embodiments, the access to the resource may be controlled based on any other suitable context (e.g., the location of the client, if it is light outside or not, if a condition is fulfilled or not). Such access control is emulated by the intermediary node, which is advantageous because the access control function may be a burden to the node if the function was implemented at the node. In particular, if the access control includes complex policies, it is preferable to not implement the access control functionality on any individual node nor to configure the access control functionality on a per node basis over a constrained network. Processing the first request by the intermediary node comprises determining whether the client is allowed to access the resource. For instance, the intermediary node may implement an access control list which grants or denies access to a resource on the node depending on the identity of the client which requested the resource. If the client is allowed to access the resource, the first response comprises the resource and is provided to the client. When the resource is supported by the node, the method further comprises forwarding the first request to the node and receiving the resource from the node. If the resource is emulated by the intermediary, the resource is retrieved locally by the intermediary and is provided to the client. If the client is not allowed to access the resource, the first response to the client may indicate an error and/or that access to the resource is denied.

According to one aspect, processing said first request comprises determining a second request. This situation may arise if the first request requests a functionality that is in part fulfilled by the second request to the node and further includes some additional processing of a response to the second request (the additional processing may not be supported by the node or may not be suitable to be performed by the node). Depending on the application, said second request is the same as the first request or different from the first request. Said second request is transmitted from the intermediary node to the node, and a second response is received from the node in response to the second request at the intermediary node. Instead of forwarding the second response to the client, the intermediary modifies the second response in accordance with the first request (i.e., according to the functionality being emulated by the intermediary) to derive the first response. Examples of the additional processing performed by the intermediary to derive the first response includes adding information to the second response, filtering out information in the second response, and/or translating or deriving information from the third response. Advantageously, the intermediary alleviates the burden of the additional processing on the node and/or enriches the resources/capabilities of the node through the emulation.

According to one aspect, the first request requests a resource (e.g., content) from the node to be returned in a first (content) format. However, the node may not support returning the resource in the first format. Thus, the intermediary node processes said first request by determining a third request. Said third request requests content from the node to be returned in a second format (that is supported by the node). The third request is transmitted to the node and a third response is received from the node in response to the third request. Said third response has the content in the second format. The intermediary then translates the content in the second format to a first format to derive the first response having the content in the first format. The second format is generally translatable from the first format. As a result, the intermediary advantageously emulates the functionality of being able to support returning a resource in a format that is not supported by the node.

According to one aspect, processing said first request at the intermediary node determining a fourth request and a fifth request which fulfills at least a first part and a second part of the functionality, respectively, to be emulated by the intermediary node. The fourth and fifth requests may include subroutines for fulfilling the functionality associated with the first requests. The fourth request and the fifth request are transmitted over the network to the node. From the node over the network, a fourth response and a fifth response to the fourth request and the fifth request, respectively are received at the intermediary node. The intermediary node then derives the first response by processing said fourth response and said fifth response in accordance with said functionality. In this case, the functionality is typically not supported by the node, and to update the node to support the functionality is not feasible or efficient. Thus, the emulation of the functionality advantageously allows the functionality to be provided without requiring the node to implement the functionality.

According to one aspect, the first request is an observe request configured to observe change(s) in a resource of the node. To emulate the observe functionality, the intermediary node polls the resource through a plurality of get requests. Accordingly, said fourth request is a first get request configured to request a first value for the resource of the node and said fifth request is a second get request configured to request a second value for the resource of the node. The fourth response has the first value and said fifth response has the second value. To provide the observe functionality, the intermediary node determines whether the first value and the second value have changed or became different. If the first value and the second value have changed, the intermediary node deriving the first response indicating the second value and/or an existence of said change in accordance with the observe functionality.

According to one aspect, the first request is a conditional observe request configured to observe whether at least one resource of the node meets a condition or a plurality of conditions. Typically, the functionality is implemented by observing whether the state has changed and whether the change meets a particular condition. In some cases, the functionality is implemented by observing the state and transmitting state (or state changes) if a condition on the timing is met. Thus, the intermediary node may implement the conditional observe functionality by polling the node for the state of the resource being conditionally observed. Accordingly, the method further comprises determining whether the second value and/or the timing of the second value meet the condition (if a change in the state of the resource has been observed). If the second value and/or the timing of the second value meet the condition, the intermediary node derives the first response having the second value and/or indicating the condition has been met.

According to one aspect, the first request is a conditional observe request configured to observe whether at least one resource of the node meets a condition. A conditional observe request may be fulfilled through observe request(s) if the node supports the observe capability. The intermediary node transmitting a sixth request, wherein said sixth request is an observe request configured to request a value for a resource of a node if the state of the resource of the node changes. A sixth response is received from the node (e.g., indicating a value of the resource and that the state of the resource has changed). The sixth response includes the sixth value, and the intermediary node determines whether the sixth value meets the condition. If the sixth value meets the condition, the intermediary node transmits the first response to the client. Said first response comprising the sixth value and/or indicating the condition has been met. Advantageously, the intermediary emulates the conditional observe functionality even though the node only supports the (less complex) observe capability.

According to one aspect, the first request is a first discovery request. The discovery request may request a list of resources made available by the node. The intermediary node may transmit a second discovery request to the node. The intermediary node then receives a second discovery response to the second discovery request from the node. To inform the client that the functionality emulated by the intermediary node is supported by the node, the intermediary node adds the functionality to the second discovery response, using a message rewriter, to derive the first response to indicate said node is configured to support said functionality. The message rewriter may be configured to perform any of the following to a message: adding resources, removing resources, changing the capabilities associated with resources, etc.

According to one aspect, the discovery request is not intercepted or no such discovery request was transmitted. In one example, the node transmits messages to a resource registry to make the supported resources/capabilities known to clients. The intermediary node makes the client aware that the node supports the emulated functionality by intercepting at least one of the following message(s) transmitted from the node: a third discovery response, said third discovery response transmitted in response to a third discovery request transmitted from the client, a resource announcement message and a resource registration message. The intermediary node, e.g., using a message rewriter, adds the functionality to the message to generate a modified message to indicate said node is configured to support said functionality. The intermediary node transmits the modified message to the client (if the client made a discovery request) and/or transmits the modified message to a resource directory (if the intermediary node intercepted a resource announcement/registration message).

According to one aspect, the intermediary node stores a previously intercepted or transmitted resource announcement/registration message. If the supported resources and/or capabilities change due to changes in the functionality emulated on the intermediary node, the intermediary node, e.g., using the message rewriter, may modify the previously intercepted/transmitted resource announcement/registration message to reflect the change.

According to one aspect, the intermediary node determines whether the first request is associated with the functionality to be emulated by the intermediary node. The intermediary node may first transmit the first request to the node to determine whether the first request is supported by the intermediary node. In some cases, the intermediary node receives a response from the node that the first request is not supported by the node and/or that an error has occurred. In such cases, the intermediary node may proceed to emulate the functionality for the node.

According to one aspect, the intermediary node is configured to transmit a request to retrieve resource(s) and/or capability(-ies) supported by the node, such that the intermediary node may determine whether the first request is supported by the intermediary node. The request may be a discovery request (e.g. the “.well-known/core” request to the node in CoAP) to retrieve information about (the existence of) a resource on the node, or a request to retrieve the capabilities of the node and/or a particular resource on the node. A response in response to said request is received by the intermediary node. The intermediary node determines from the response whether the first request is supported by the node.

According to one aspect, the intermediary node determines, from a storage of functionalities that the intermediary node is configured to emulate for the node, whether the first request is associated with any of the functionalities in the storage, said storage being at the intermediary node and/or communicably connected to the intermediary node. For instance, the storage may store correspondences between a request and (other) request(s) for fulfilling an emulated functionality. In another instance, the storage may store correspondences between a request and resource(s) for emulating resource(s) not supported by the node. In yet another instance, the storage may store correspondences between a request, and additional processing for fulfilling an emulated functionality.

According to one aspect, the node comprises a constrained device. When functionality is emulated for a constrained device, the functionality is performed on behalf of the constrained device. The advantages of the disclosed embodiments are particularly evident for constrained devices, which are often not suitable candidates for implementing the functionality emulated by the intermediary node.

According to another aspect, the node is communicably connected to the intermediary node over a low power and lossy network. In these situations, offloading the functionality to an intermediary node may provide more reliability in providing the functionality to the client, because the client may be communicably connected with the node over a more reliable network than the low power and lossy network.

An intermediary node for emulating a functionality for a node is disclosed. Said intermediary node is communicably connected to a network, the intermediary node comprises a receiver, a functionality emulator, and a transmitter. The receiver is configured to intercept, a first request transmitted over the network from a client. The functionality emulator configured to determine whether the first request is associated with the functionality to be emulated by the intermediary node for the node. If the first request is associated with the functionality to be emulated by the intermediary node, the functionality emulator is configured to process said first request at the intermediary node in accordance with said functionality to derive a first response. The transmitter is configured to transmit said first response to the client over the network.

The nodes for whom the functionality is emulated may be a network of nodes, e.g., a lossy network of nodes, a constrained network. The intermediary node may be located at an edge of the network of nodes to facilitate the interception of communications between client(s) and node(s).

A system comprising at least one node and an intermediary node is disclosed. Said intermediary node may be communicably connected to the at least one node. The intermediary node may be communicably connected to at least one client configured to transmit requests, e.g., the first request, destined to the at least one node.

The disclosure may also relate to a computer program product, implemented on computer-readable non-transitory storage medium, wherein the computer program product may comprise software code portions configured for, when run a computer, executing the method steps according to any of the methods described in the present disclosure. The computer program product is preferably implemented at least in part in any of: a client, a server, a node, a gateway node, an intermediary node, a receiver, a transmitter, a functionality emulator, a storage, etc.

The disclosure will further be illustrated with reference to the attached drawings, which schematically show embodiments according to the disclosure. It will be understood that the disclosure is not in any way restricted to these specific embodiments. Hereinafter, embodiments of the invention aiming to alleviate the problem(s) described above will be described in further detail. Moreover, combinations of any of the embodiments and limitations are envisioned by the disclosure.

### BRIEF DESCRIPTION OF THE DRAWINGS

Aspects of the invention will be explained in greater detail by reference to exemplary embodiments shown in the drawings, in which:

FIG. 1 shows an illustrative system comprising clients, servers, and an intermediary node in a network, according to one embodiment of the disclosure;

FIG. 2 shows an exemplary messaging diagram illustrating the emulation of a resource for a node, according to one embodiment of the disclosure;

FIG. 3 shows an exemplary messaging diagram illustrating the emulation of access control for a node, according to one embodiment of the disclosure;

FIG. 4 shows an exemplary messaging diagram illustrating the emulation of support for a particular content format for a node, according to one embodiment of the disclosure;

FIG. 5 shows an exemplary messaging diagram illustrating the emulation of observe functionality for a node, according to one embodiment of the disclosure;

FIG. 6 shows an exemplary messaging diagram illustrating the emulation of conditional observe functionality for a node, according to one embodiment of the disclosure;

FIG. 7 shows an exemplary messaging diagram illustrating the emulation of functionality for a node, according to one embodiment of the disclosure;

FIG. 8 shows an exemplary messaging diagram illustrating augmenting a resource discovery response for a node, according to one embodiment of the disclosure;

FIG. 9 shows an exemplary messaging diagram illustrating augmenting a resource announcement/registration message for a node, according to one embodiment of the disclosure; and

FIG. 10 shows an exemplary messaging diagram illustrating augmenting a message for indicating the support of the functionality to be emulated for a node, according to one embodiment of the disclosure.

### DETAILED DESCRIPTION

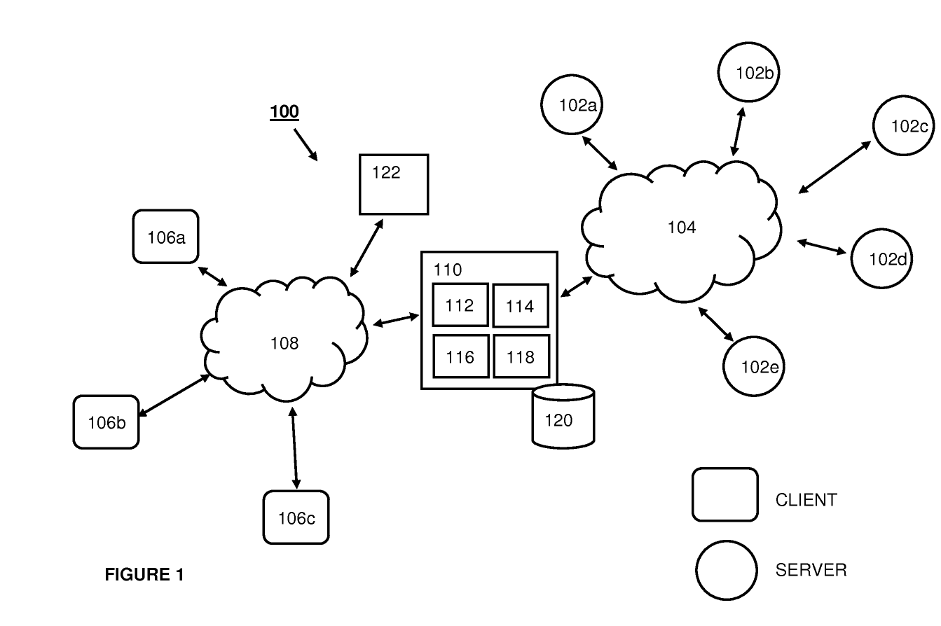

FIG. 1 shows an illustrative system comprising client(s), node(s), and an intermediary node in a network, according to one embodiment of the disclosure. System 100 comprises at least one client 106a-c, at least one node 102a-e (e.g., a constrained node acting as a server or a plurality of servers), and at least one intermediary node 110. Clients may include (user) applications configured to transmit requests to nodes acting as servers. The clients may request information regarding resource(s) on a node, and/or to request the node to perform an action according to the capability(-ies) of the node.

The clients may be communicably connected to a first communication network 108, such as a wired or wireless network. The nodes may be communicably connected to a second communication network 104 (may be the same network as the first communication network), such as a wired or wireless network. In some cases, the second communication network is lossy and/or unreliable. Generally, the clients are configured to access the nodes through a server-client relationship, using a protocol such as Constrained Application Protocol (CoAP) to transmit communications over the first communication network and the second communication network.

An intermediary node is communicably connected to the client(s) and the node(s) to intercept communications between a client and a node over the first communication network and the second communication network. An intermediary node may include a receiver 112, a transmitter 116, a functionality emulator 114, and a message modifier 118. The receiver is configured to intercept requests transmitted over the first communication network, where the requests are destined to a node. The intermediary node is preferably located at an edge of a network that the nodes are communicably connected to facilitate the interception of requests destined to the nodes. If applicable, the transmitter is configured to transmit requests over the second communication network to a node. Preferably, the intermediary node is less constrained than at least some of the nodes. For instance, the intermediary node may be connected to a mains power source, and the node may be powered by a battery. The processing power of the intermediary node may be substantially greater than the processing power of the node.

To emulate a functionality for a node, the intermediary node includes and/or is communicably connected to a storage 120 of functionality(-ies) to be emulated. A functionality to be emulated may include providing resource(s) and/or capability(-ies) on behalf of a node. Accordingly, the storage may include resources and/or capabilities associated with nodes for which the intermediary node emulates, and preferably content/process(es) needed to emulate the functionality.

In one embodiment, the functionality emulator of the intermediary node determines whether a request (destined to a node) is associated with a functionality to be emulated by the intermediary node. The determination may be performed by checking the request received against a list of functionality(-ies) that the intermediary node is capable of emulating for the node or for any node in the network. Said list of functionalities may be stored in the storage. If the request is associated with any of the functionalities in the list, the intermediary node is configured to emulate (i.e., carry out) the functionality. If the request is not associated with any of the functionalities in the list, the request may be forwarded to the node. Typically, the functionality to be emulated is not supported by the node or the functionality is not suitable to be performed by the node. The functionality emulator then emulates the functionality to be emulated (e.g., by fulfilling the functionality on behalf of the node and performing steps associated thereto).

In certain embodiments, the list of functionality(-ies) may be associated with particular client(s). Accordingly, the functionality may be provided to certain client(s) and not to other client(s). Thus, the determination of whether a request is associated with a functionality to be emulated by the intermediary node further comprises checking the identity/identifier of the client from which the request is sent against the list of functionality(-ies) in the storage.

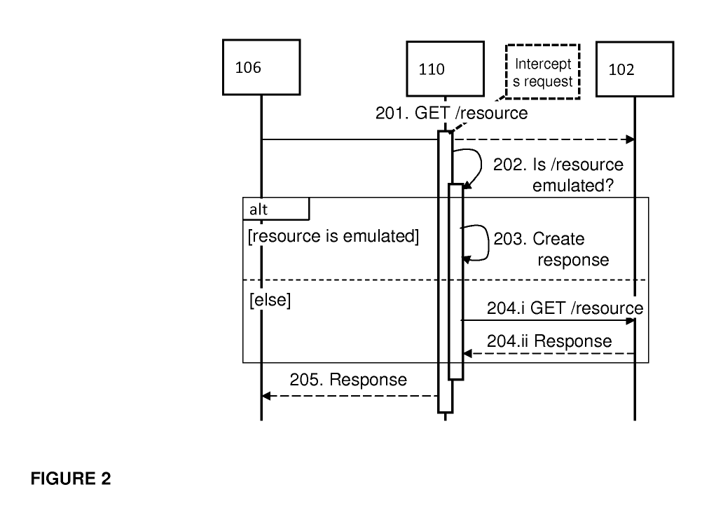

Upon determining that the functionality is to be emulated by the intermediary node, the functionality emulator processes the request according to the functionality to generate a response. Examples of such processing are explained in further detail in relation to FIGS. 2-7. The response is then transmitted to the client. The response may be transmitted to the client as if it had originated from the node.

In some embodiments, the functionality to be emulated is predetermined by, e.g., an operator of the nodes. In some embodiments, the intermediary node may advantageously determine itself whether the functionality associated with the (intercepted) request ought to be emulated by the intermediary node. The intermediary node may transmit the request to the node to determine whether the node supports the request. In some embodiments, the intermediary node may transmit a request to retrieve resource(s) and/or capability(-ies) supported by the node, such that the intermediary node may determine whether the first request is supported by the intermediary node. The intermediary node may then determine from the response to that request whether the intercepted request is supported by the node.

If the node returns an error and/or an indication that the request is not supported (or in some cases no response is received), the intermediary may add the request to the list of functionalities to be emulated to the storage.

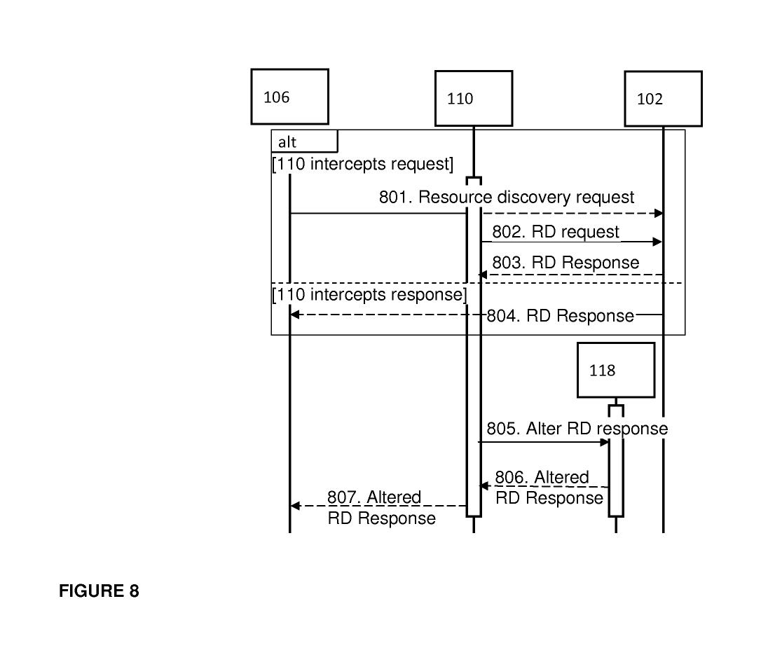

To enable clients to know that the functionality to be emulated (by the intermediary node) for the node is available or supported by that node, the message rewriter of the intermediary node is configured to modify/augment messages in the network to, e.g., indicate to a client that the functionality is supported by the node. Examples of rewriting these messages are discussed in further detail in relation to FIGS. 8-10. In some embodiments, a resource directory 122 is provided such that a directory is maintained of the resources and/or capabilities supported by the nodes. Clients and/or nodes are communicably connected to the resource directory through the first communication network and/or the second communication network. In some embodiments, the resources and/or capabilities supported by the nodes includes the functionality(-ies) to be emulated for the node.

FIG. 2 shows an exemplary messaging diagram illustrating the emulation of a resource for a node, according to one embodiment of the disclosure. A client 106 transmits a request to a node 102 to get a resource (step 201). An intermediary node 110 (e.g., the receiver) intercepts the request and determines whether the resource is to be emulated by the intermediary node (step 202), e.g., whether the resource is to be provided by the intermediary node instead of the node. For instance, the intermediary node may determine from the storage of functionalities to be emulated whether the resource is to be emulated by the intermediary node. Furthermore, the resource is available at the intermediary node. For instance, the resource is stored in a storage of the intermediary node.

In some embodiments, a resource of a node includes information and/or content about or associated with the node. One example of a resource is a digital photo of the node. The node, e.g., a constrained node, may not be adapted or suitable to provide the digital photo of the node, and the intermediary node may provide the digital photo as an added functionality to the node. As a result, the emulation of the resource enables a more capable and efficient entity, i.e., the intermediary node, to provide the resource on behalf of the node. Advantageously, the description for the node is enriched by the intermediary node's emulation of the resource.

If the resource is to be emulated for the node, the intermediary node (e.g., the functionality emulator of the intermediary node) processes the request by retrieving the resource from the storage. A response is created from the retrieved resource (step 203), and the response is transmitted to the client (e.g., by the transmitter of the intermediary node) which transmitted the request (step 205). In other words, the response is generated locally at the intermediary node and the node is not burdened with the request for the resource. Optionally, the response may be transmitted as if the response had originated from the node, and the client is not aware that the resource had been provided by the intermediary node.

If the resource is not emulated for the node, the intermediary node may forward the request to the node (step 204.i). A response may be transmitted from the node with the resource to the intermediary node (step 204.ii) and the response is forwarded to the client (step 205). Alternatively, the response may be transmitted directly to the client without going through the intermediary node.

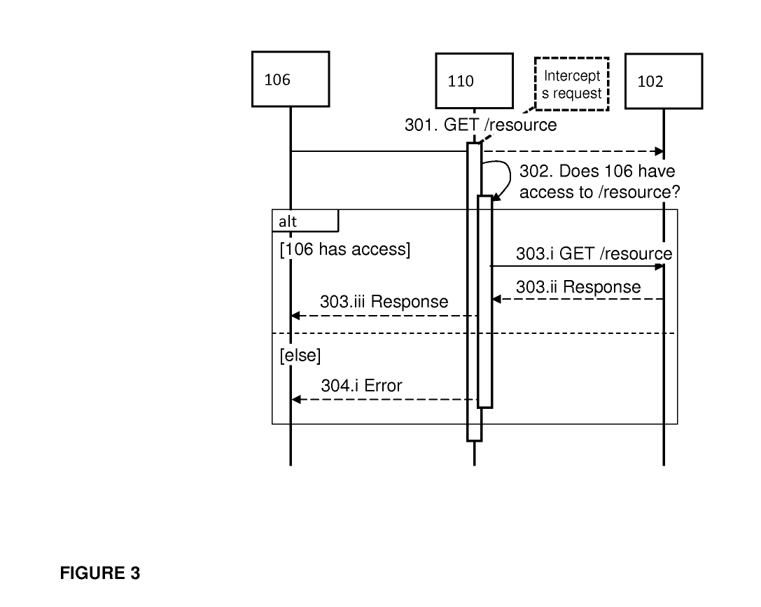

FIG. 3 shows an exemplary messaging diagram illustrating the emulation of access control for a node, according to one embodiment of the disclosure. Rather than implementing the functionality of access control at the node (e.g., which may require significant computational resources), the functionality of access control is emulated at the intermediary node. A request to get a resource is transmitted from the client and the request is destined to the node (step 301). The intermediary node (e.g., the receiver of the intermediary node) intercepts the request. The intermediary node may determine from the request whether the requested resource requires access control (e.g., at the functionality emulator of the intermediary node by checking the storage of functionality(-ies) to be emulated), or alternatively, access control to the resource is enabled by default. If the intermediary node determines that the functionality of access control is to be emulated, the intermediary (e.g., the functionality emulator) determines whether the client, from whom the request is transmitted, is allowed to access the requested resource (step 302). For instance, an identifier of the client is extracted from the request and the identifier of the client is checked against an access control list. Although access control based on the identifier of the client is described in this specific example, other forms of access control (e.g., based on other conditions or contexts are envisioned). The access to the resource may be controlled based on time (e.g., only during office hours). In some embodiments, the access to the resource may be controlled based on any other suitable context (e.g., the location of the client, if it is light outside or not, if a condition is fulfilled or not). In another instance, a digital certificate of the client may be checked to determine the client's authenticity, and the client's identity is checked to determine the client's authorization to access the requested resource. Such an operation is typically not supported by a constrained node. Implementing said access control functionality relieves the burden for the node to implement said functionality. This feature also allows for a single access policy that only has to be enforced at the intermediary node instead of having a plurality of access policies enforced separately at the plurality of nodes.

If the client is allowed to access the resource, a response comprising the resource is provided to the client (step 303.iii). If the client is not allowed to access the resource, a response indicating an error (e.g., providing an error code in the response), that the client is not allowed to access the resource, and/or that the access to the resource is denied may be transmitted to the client (step 304). In some embodiments, a response may not be sent at all, and the lack of a response may indicate to a client that the resource does not exist or the client has no access to the resource.

Given that the client is allowed to access the resource, the requested resource may be provided in different ways. If the requested resource is emulated by the intermediary node (e.g., as in FIG. 2), the response is generated locally at the intermediary node. If the requested resource is not emulated by the intermediary node, the request is forwarded (e.g., by the transmitter of the intermediary node) to the node (step 303.i), and a response comprising the resource is received from the node at the intermediary node (step 303.ii). The response may be forwarded to the client (step 303.iii). Alternatively, the node may transmit the response having the requested resource directly to the client.

Depending on the implementation of the access control functionality, the intermediary node may enforce access control policies on responses that are transmitted from a node. For instance, the intermediary node may intercept responses originated from a node and destined to a particular client. Based on the access control functionality, the intermediary node determines that the particular client does not have access to the resource in the intercepted response. The intercepted response is then not forwarded to the client and the client does not receive the response.

A similar functionality of access control to a capability of the node may also be emulated by the intermediary node. Instead of a request for a resource is transmitted from the client, a request for a capability of the node is transmitted requesting the node to perform the capability. The intermediary node intercepts the request and determines whether the client is authorized to request the capability. If the client is authorized, the request for the capability is forwarded to the node. If the client is not authorized (even though the node is capable of providing the capability), a response indicating an error (and any suitable variations of such a response) may be transmitted to the client to indicate that the client is not authorized to request the capability. In some cases, a response is not transmitted at all.

The functionality to provide access control to resources and/or capabilities provides the advantage of virtualization. When a node is managed by stakeholder X and is accessible/used by multiple stakeholders X and Y. The stakeholder X may use the intermediary node to restrict stakeholder Y from certain resource(s) and/or capability(-ies). For instance, stakeholder X may not want to allow stakeholder Y or any other party to make updates to the node. Virtualization allows different stakeholders a different access to the resources and/or capabilities. In other words, emulated functionality(ies) available to a particular client may vary.

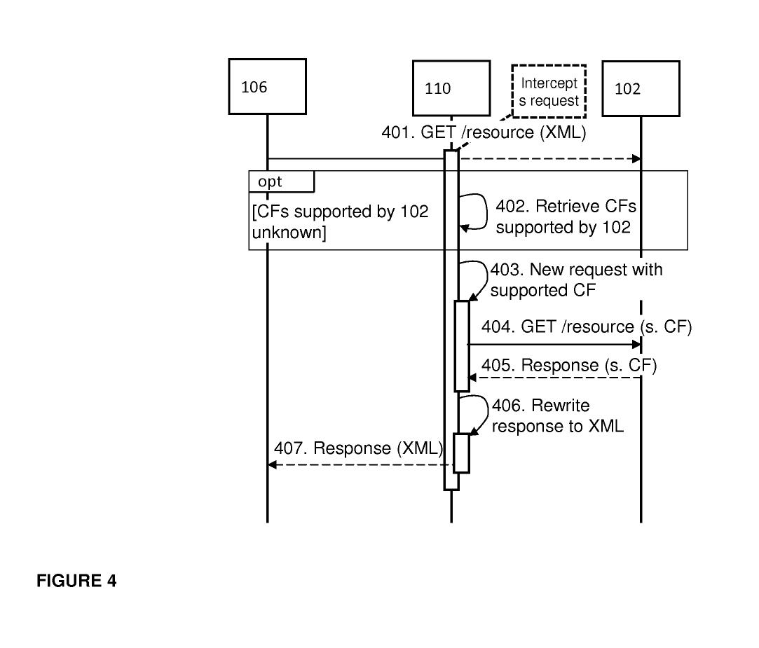

FIG. 4 shows an exemplary messaging diagram illustrating the emulation of support for a particular content format for a node, according to one embodiment of the disclosure. The intermediary node, preferably having more computational power and/or computational resources, may provide added functionality to the node by translating content (i.e., a resource) provided by the node from one format to another. The client is thus, advantageously enabled by the intermediary node, able to request a resource in a format that is not supported by the node. A first request for a resource in a first format is transmitted from the client and the request is destined to the node (step 401). For instance, the request for a resource requests the resource to be returned in Extensible Markup Language (XML)-format.

Optionally, the intermediary node is configured to determine whether the first request for the resource in the first format is to be emulated by the functionality. If the first request for the resource in the first format is forwarded to the node and the request is rejected by the node because the node does not support providing the resource in the first format, the intermediary node may be configured to emulate providing the resource in the first format. Alternatively or additionally, the intermediary node may determine the content format(s) that are supported by the node for returning the resource (step 402) by retrieving the supported content format(s). The retrieval of supported content format(s) may be performed through a profile description of the node, a resource discovery process, and/or some other suitable resource directory service. The intermediary node may determine whether the intermediary node is configured to translate from any of the supported content format(s) to the first content format. The correspondence between first format to the supported content format(s) (and associated request(s) for requesting the resource in those supported content format(s)) may be stored in a storage of the intermediary node to enable the intermediary node to determine (e.g., for future requests) a second request suitable for fulfilling the first request. The correspondence further enables the intermediary node to determine whether the request is associated with a functionality to be emulated (i.e., associated with a content format whose support is emulated by the intermediary node).

For instance, the node supports returning the resource in a second format different from the first format. The intermediary node (e.g., the functionality emulator of the intermediary node) accordingly determines a second request requesting the resource to be returned in the second format (step 403). The second request is transmitted to the node (step 404), and a response is received from the node at the intermediary node (step 405). The intermediary node, configured to translate the provided resource (i.e., content) from the second format to the first format, derives a translated resource in the first format based on the received resource in the second format (step 406). The intermediary node modifies the response to include the translated resource and transmits the modified response (on behalf of the node) (step 407) to the client in the first format. For instance, the received resource is translated into XML-format, and a response (in response to the first request) is derived in XML-format.

In some embodiments, the functionality to be emulated includes intercepting one (or more) request(s) and transmitting a plurality of requests to a node in order to fulfill the functionality. The intermediary node may process the responses from the plurality of requests to fulfill the functionality, e.g., to provide more complex processing function(s) that is not supported or implemented by the node. Accordingly, the processing of a first request comprises determining a second request and a third request, which respectively fulfills a first part and a second part of the functionality. For instance, the first request may include subroutines, which may be fulfilled by the second request and the third request. In another instance, the first request may request information, which is derivable from responses of other requests. The intermediary node may maintain in the storage a correspondence between the first request and the corresponding plurality of requests for fulfilling the first request.

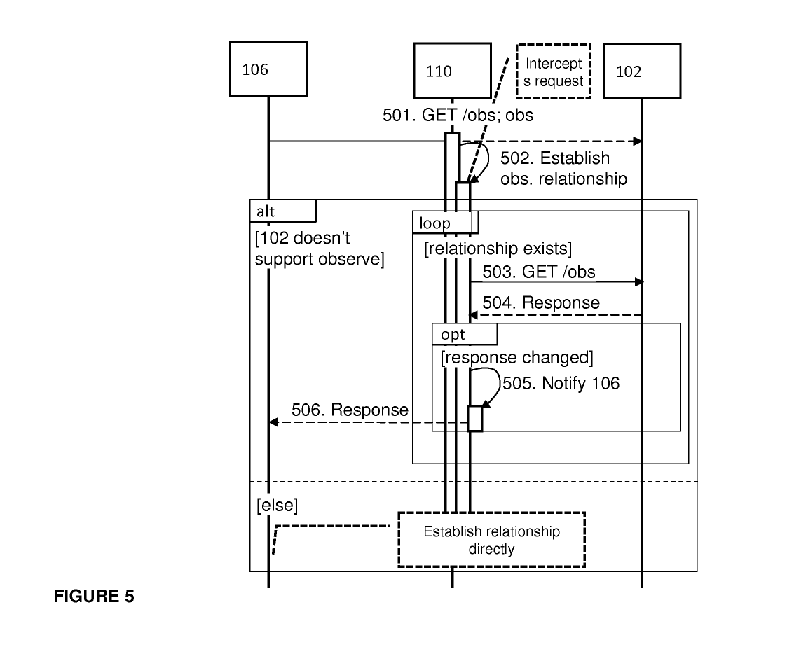

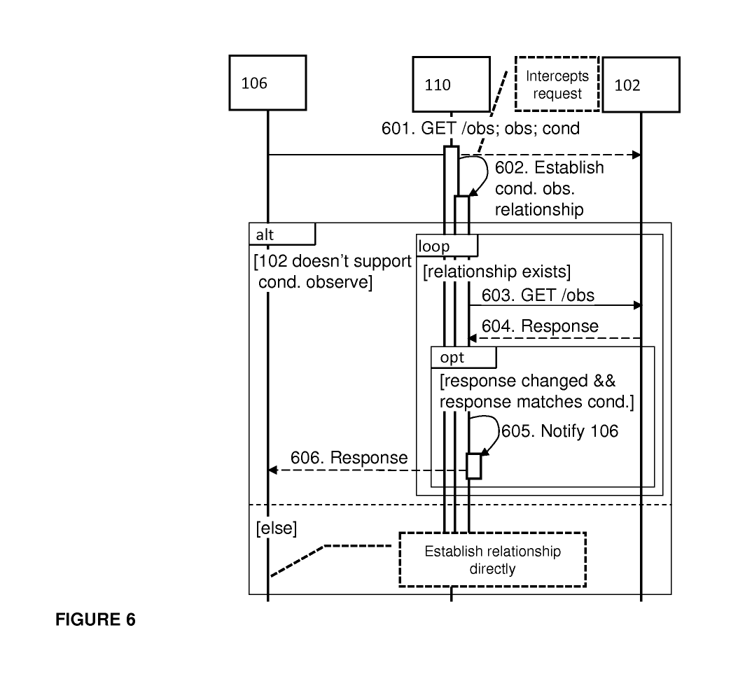

The second request and the third request for fulfilling the functionality are transmitted over the network to the node. Respectively, a second response and a third response are received from the node. The second response and the third response are processed by the intermediary node, and the intermediary node derives a first response to the first request based on the second response and the third response. As a result, a more complex functionality is fulfilled by the intermediary node on behalf of the node. Examples of such emulation are explained in detail in relation to FIGS. 5 and 6.

FIG. 5 shows an exemplary messaging diagram illustrating the emulation of observe functionality for a node, according to one embodiment of the disclosure. In some applications, a client may request to establish a relationship to observe a resource of a node for changes in the state of the resource. If the state of the resource changes, the client is notified of the change in the state of the resource. Such an observe relationship (e.g., as proposed in CoAP as an optional feature) may be emulated by a plurality of get requests (i.e., by polling the resource of the node). Accordingly, the observe functionality may be implemented at the intermediary node instead of the node.

A request to observe a resource is transmitted from the client and the request to observe the resource is destined to the node (step 501). The intermediary node intercepts the request to observe the resource. The intermediary node may determine whether the request to observe the resource is to be emulated by the intermediary node. For instance, the intermediary node, e.g., through a discovery process, determines that the node does not support the observe functionality.

Accordingly, the intermediary node may store in the storage that the observe functionality may be emulated by the intermediary node. If the node supports the observe functionality, the request to observe the resource may be forwarded to the node and the observe relationship may be established directly between the client and the node.

If the node does not support the observe functionality, the intermediary node may establish the relationship internally to observe the resource with the node (step 502), and is configured to observe the resource through a series of requests to get the state of the resource (step 503). From the responses to the series of requests (step 504), change(s) to the state of the resource is determined by comparing the states reported by the node in the responses. For instance, one response may report a first temperature reading of 22 degrees and another response may report a second temperature reading of 23 degrees. The intermediary node may determine the change in the state of the resource (i.e., the temperature) by comparing the first temperature reading with the second temperature reading to determine whether there is a difference or a change.

If the state has changed from one response to the other, a notification response may be derived by the intermediary (step 505) and a response to the observe request is transmitted to the client (step 506). The observe relationship is thus maintained internally by the intermediary node and the observe functionality is advantageously emulated at the intermediary node even though the node may not support the observe functionality. The emulated observe functionality alleviates the node from having to implement the logic for observing a state of the resource. Furthermore, the emulated observe functionality at the intermediary node alleviates the client from having to continuously poll the node for obtaining changes in a state of a resource (which may have to occur over costly communication links, or links may experience sporadic delays). Advantageously, the intermediary performs the polling and reports state changes on behalf of the node.

FIG. 6 shows an exemplary messaging diagram illustrating the emulation of conditional observe functionality for a node, according to one embodiment of the disclosure. A more complex functionality than the observe functionality may be emulated by the intermediary node. In some applications, a client may request to establish a relationship to conditionally observe a resource of a node for changes in the state of the resource, and/or to observe the state of a resource based on a timing condition. For instance, the client may ask to be notified if the change in the state of the resource meets a particular condition (e.g., only being informed about state changes meeting a specific condition or set of conditions). In another instance, the client may ask to be notified if a condition regarding timing is met, e.g., asking to be notified according to a condition which specifies when the state or changes in the state should be transmitted to the client. If the condition is met, the client is notified. For instance, a request to such a conditional observe relationship (e.g., as proposed in CoAP as an optional feature) may be implemented by a plurality of get requests (i.e., by polling the resource of the node). Accordingly, the conditional observe functionality may be implemented at the intermediary node instead of the node.

A request to conditionally observe a resource is transmitted from the client and the request to conditionally observe the resource is destined to the node (step 601). The request includes an indicator for the resource to be observed. Furthermore, the request includes one or more condition, e.g., a condition to be met by (the changes in) the state of the resource and/or a condition associated with timing of when resource states or resource changes are transmitted. The intermediary node intercepts the request to conditionally observe the resource. The intermediary node may determine whether the request to conditionally observe the resource is to be emulated by the intermediary node. For instance, the intermediary node, e.g., through a discovery process, determines that the node does not support the conditional observe functionality. Accordingly, the intermediary node may store in the storage that the conditional observe functionality may be emulated by the intermediary node. If the node supports the conditional observe functionality, the request to conditionally observe the resource may be forwarded to the node and the conditional observe relationship may be established directly between the client and the node.

If the node does not support the observe functionality, the intermediary node may establish the relationship internally to conditionally observe the resource with the node (step 602), and is configured to observe the resource through a series of requests to get the state of the resource (step 603).

In one embodiment, the conditional observe request requests to be notified if a change in the state of the resource meet a certain condition. From the responses to the series of requests (step 604), change(s) to the state of the resource is determined by comparing the states reported by the node in the responses. If there is a change to the state, the (latest) state of the resource reported by the node is checked against the condition. For instance, one response may report a first temperature reading of 22 degrees and another response may report a second temperature reading of 23 degrees. The intermediary node may determine the change in the state of the resource (i.e., the temperature) by comparing the first temperature reading with the second temperature reading to determine whether there is a difference or a change. Furthermore, if there exists a change in the state, the second temperature reading is checked against a condition. For example, the client requests to be notified if the temperature changes and is below 25). Because the second temperature reading of 23 degrees meets the condition, a response notifying the client is derived.

In some embodiments, the conditional observe request requests to be notified if a state of the resource meet a certain timing condition. The intermediary node thus checks whether the reported state of the resource meets the timing condition.

If the condition is met (and if there was a change in the state), a notification response may be derived by the intermediary (step 605) and a response to the conditional observe request is transmitted to the client (step 606). The conditional observe relationship is thus maintained internally by the intermediary node, and the conditional observe functionality is advantageously emulated at the intermediary node even though the node may not support the conditional observe functionality. The emulated conditional observe functionality alleviates the node from having to implement the logic for conditionally observing a state of the resource. Furthermore, the emulated conditional observe functionality at the intermediary node alleviates the client from having to continuously poll the node for obtaining changes in a state of a resource (which may have to occur over costly communication links, or links may experience sporadic delays). By providing the emulated functionality of conditional observe, the intermediary node may limit the resource states that are transferred to the client to those in which the client is actually interested. Advantageously, the intermediary performs the polling and reports state changes or states that meet the condition on behalf of the node.

Alternatively, if the node supports the observe functionality but does not support the conditional observe functionality, the conditional observe functionality may be emulated by the intermediary node through an observe request transmitted from the intermediary node to the node. The intermediary node is thus informed of all changes to the state of the resource, and those changes may be checked against the condition in the conditional observe request internally at the intermediary node. For instance, the intermediary node may transmit a request being an observe request configured to request a value for a resource of a node if the state of the resource of the node changes. If the state of the resource changes, the intermediary node may receive a response from the node comprising a value of the response. The intermediary node then emulates the conditional observe functionality by determining whether the value meets the condition. If the value meets the condition, the intermediary node generates and transmits a response to the client, said first response comprising the value and/or indicating the condition has been met. Advantageously, the logic needed to implement conditional observe functionality is at the intermediary node and the node is alleviated of the need to have said logic.

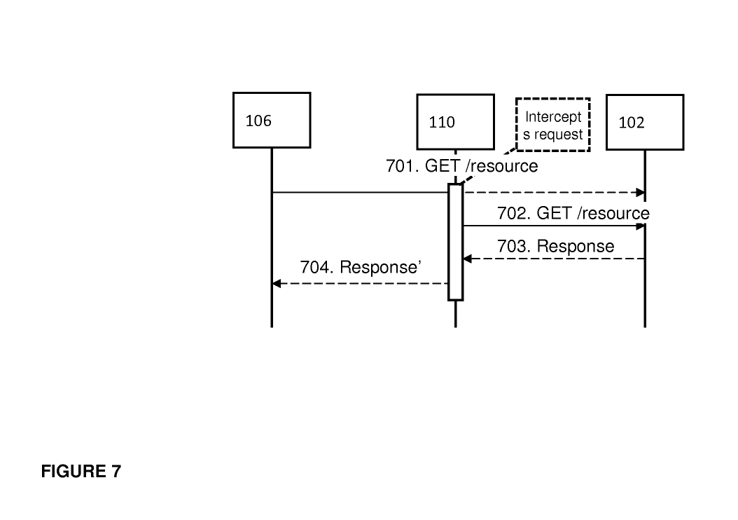

FIG. 7 shows an exemplary messaging diagram illustrating the emulation of functionality for a node, according to one embodiment of the disclosure. In some applications, the intermediary node emulates a functionality for the node by modifying a response that is transmitted from a node such that an added/extra functionality is provided to the client. For example, a request to the node may be associated with a functionality that is not fully supported by the node or the functionality that is to be emulated by the intermediary is not supported by the node.

A request is transmitted from a client and the request is destined to the node (step 701). The intermediary node may forward the request to the node (step 702). In some cases, a different request is transmitted to the node, if a different request is needed to fulfill the emulated functionality. A response is received at the intermediary node (step 703). A modified response is generated in accordance with the functionality being emulated and is transmitted to the client (step 704). A modified response may be generated in different ways. For instance, the response may be filtered (in accordance with the functionality being emulated) such that only a part of the information in the response is provided in the modified response. In another instance, information may be added to the response (in accordance with the functionality being emulated) to generate a modified response having the added information. One example includes adding a cost of the transaction to a response to generate a modified response (e.g., for constrained nodes with a subscriber identity module card). Another example includes adding a timestamp to the response to generate a modified response as a performance metric indicating the delay of the request (e.g., for an intermediary node located at a border of a constrained network).

If a functionality is emulated by an intermediary, it is advantageous to make sure that clients are aware that the functionality is virtually supported by the node. Several ways of allowing clients to be aware of the emulated functionality are explained in relation to FIGS. 8-10.

FIG. 8 shows an exemplary messaging diagram illustrating augmenting a resource discovery response for a node, according to one embodiment of the disclosure. In some applications, a client transmits a resource discovery request destined to a node to request the node to provide an indication of resources and/or capabilities supported by the node (step 801). The intermediary node may intercept the discovery request and transmits a resource discovery request to the node (step 802). A discovery response is received from the node indicating the resources and/or capabilities supported by the node (step 803). Rather than intercepting the discovery request or in addition to intercepting the discovery request, the discovery request may be simply sent from the client to the node, and the discovery response is intercepted by the intermediary node (step 804). The intermediary node may provide the discovery response to the message rewriter (e.g., message rewriter 118 of the intermediary node in FIG. 1) to augment/alter the discovery response to indicate that the functionality being emulated by the intermediary node is supported by the node (step 805). The augmented (altered) discovery response is derived (step 806) and the augmented discovery response is transmitted to the client to indicate that the node is configured to support the functionality (step 807).

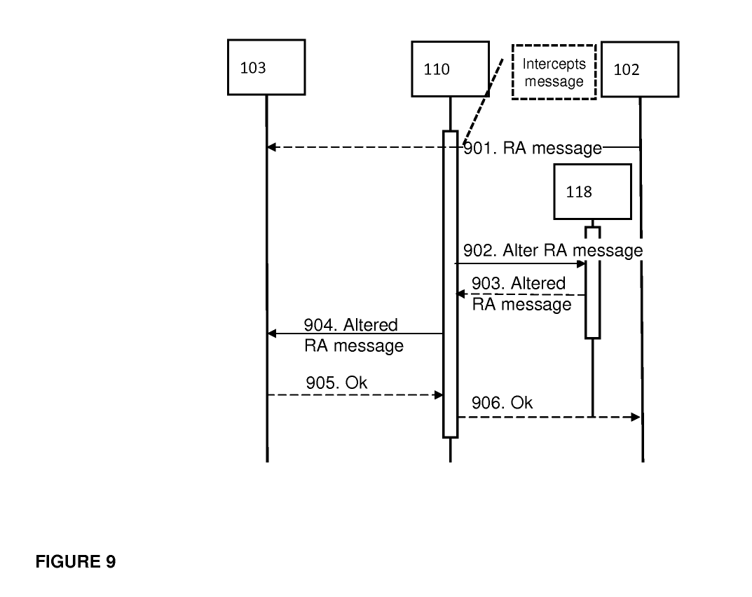

FIG. 9 shows an exemplary messaging diagram illustrating augmenting a resource announcement/registration message for a node, according to one embodiment of the disclosure. In situations where the support of resources/capabilities is maintained in a resource directory, resource announcement messages and resource registration messages to the resources registry are intercepted and augmented by a message rewriter. For instance, the node announces (in some cases without an explicit request from a client or a resource directory) the resources and/or capabilities supported by the node, e.g., to a resource directory. A response requesting the resource “./well-known/core” from a node provides a client or the intermediary node all the resource(s) and/or capability(-ies) available for a node. If this “./well-known/core” resource is observable, a client and/or an intermediary node may observe this resource, receiving notifications every time the resource changes. These notifications can be considered as resource announcement messages to a client. A resource registration message may be a message from a client and a resource registry for registering the available resource(s) and/or capability(-ies) to the resource registry.

A resource announcement message is destined to a resource directory and the resource announcement message from the node is intercepted (step 901). The intermediary node may provide the resource announcement message to the message rewriter (e.g., message rewriter 118 of the intermediary node in FIG. 1) to augment/alter the resource announcement message to indicate that the functionality being emulated by the intermediary node is supported by the node (step 902). The augmented (altered) resource announcement message is derived (step 903) and the augmented resource announcement message is transmitted to the resource registry to indicate that the node is configured to support the functionality (step 904). The resource registry may indicate an acknowledgement in an OK message (step 905), which may be forwarded onto the node (step 906).

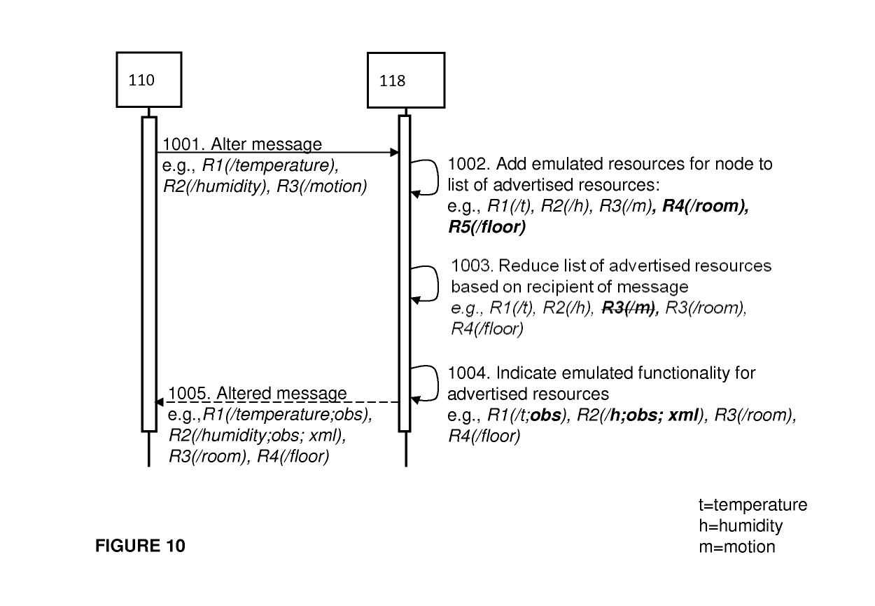

FIG. 10 shows an exemplary messaging diagram illustrating augmenting a message for indicating the support of the functionality to be emulated for a node, according to one embodiment of the disclosure. To augment/alter the messages which indicate the resources and/or capabilities supported by the node (either messages destined to the client and/or the resource directory), these messages are provided by the intermediary node to a message rewriter (e.g., the message rewriter 118 in FIG. 1) to augment the messages (step 1001). Exemplary augmentations to the messages are shown in bold in the figure.

For instance, the message may indicate that the resource “/temperature”, the resource “/humidity”, and the resource “/motion” are available for the node. Various ways of augmenting the message by the message rewriter are envisioned. For example, emulated resource(s) may be added to the message, such as the resource “/room”, and the resource “/floor” (step 1002). In another example, the supported resources may be reduced (e.g., due to access control and based on the identity of the client) such as the resource “/motion” may be removed (step 1003). In yet another example, the observe function (or any suitable function to be emulated) for a resource, such as the observe function for the resource “/temperature”, may be emulated by the intermediary node and the support for the observe capability may be added to the message (step 1004). In some cases, the content format for returning a resource, such as the ability to observe the resource “/humidity” and return the humidity in XML format, may be emulated by the intermediary and the functionality is accordingly added (step 1004). The augmented message indicating the functionality to be emulated is supported by the node is provided to the intermediary node (step 1005).

FIGS. 2-10 are described in terms of steps to be performed and/or messages to be transmitted in a particular sequence, but it is not to be construed that the steps described must be performed in the exact order described and/or one after another. One skilled in the art may envision to change the order of the steps and/or to perform steps in parallel to achieve equivalent technical results.

With some modifications, one skilled in the art may extend the embodiments described herein to other architectures, networks, or technologies.

Various embodiments of the invention may be implemented as a program product for use with a computer system or a processor, where the program(s) of the program product define functions of the embodiments (including the methods described herein). In one embodiment, the program(s) can be contained on a variety of non-transitory computer-readable storage media (generally referred to as “storage”), where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored.

It is to be understood that any feature described in relation to any one embodiment may be used alone, or in combination with other features described, and may also be used in combination with one or more features of any other of the embodiments, or any combination of any other of the embodiments. Moreover, the invention is not limited to the embodiments described above, which may be varied within the scope of the accompanying claims.

1. A method for emulating a functionality for a node communicably connected to a network, the method comprising:
intercepting, at an intermediary node communicably connected to the network, a first request transmitted over the network from a client;
determining whether the first request is associated with the functionality to be emulated by the intermediary node for the node;
if the first request is associated with the functionality to be emulated by the intermediary node:
processing said first request at the intermediary node on behalf of the node in accordance with said functionality to derive a first response; and
transmitting said first response to the client over the network.

2. The method according to claim 1, wherein the functionality is not supported by the node or the functionality is not suitable to be performed by the node.

3. The method according to claim 1, if the first request is not associated with the functionality to be emulated, forwarding the first request to the node.

4. The method according to claim 1, wherein:
the first request requests for a resource that does not exist on the node;
processing said first request comprises retrieving the resource at a storage of the intermediary node; and
the first response comprises the retrieved resource.

5. The method according to claim 1, wherein:
the first request requests for a resource;
processing said first request comprises determining whether the client is allowed to access the resource;
if the client is allowed to access the resource, the first response comprises the resource, the method optionally further comprising forwarding the first request to the node and receiving the resource from the node;
if the client is not allowed to access the resource, the first response indicates that access to the resource is denied.

6. The method according to claim 1, wherein processing said first request comprises:
determining a second request, said third request optionally different from the first request;
transmitting said second request to the node;
receiving a second response from the node in response to the third request;
modifying the second response in accordance with the first request to derive the first response.

7. The method according to claim 1, wherein:
the first request requests content from the node to be returned in a first format;
processing said first request comprises:
determining a third request, said third request requesting content from the node to be returned in a second format;
transmitting said third request to the node;
receiving a third response from the node in response to the third request, said third response having the content in the second format;
translating the content in the second format to a first format to derive the first response having the content in the first format.

8. The method according to claim 1, wherein processing said first request at the intermediary node comprises:
determining a fourth request and a fifth request which fulfills at least a first part and a second part of the functionality, respectively; and
transmitting the fourth request and the fifth request over the network to the node;
receiving, from the node over the network, a fourth response and a fifth response to the fourth request and the fifth request, respectively;
deriving first response by processing said fourth response and said fifth response in accordance with said functionality.

9. The method according to claim 8, wherein:
the first request is an observe request configured to observe change(s) in a resource of the node; and
said fourth request is a first get request configured to request a first value for the resource of the node;
said fifth request is a second get request configured to request a second value for the resource of the node;
said fourth response has the first value and said fifth response has the second value;
processing said first request comprises:
determining whether the first value and the second value, respectively, have changed;
if the first value and the second value have changed, deriving the first response indicating the second value and/or an existence of said change;
optionally:
wherein the first request is a conditional observe request configured to observe at least one resource of the node according to a condition;
processing said first request further comprises determining whether the first value and the second value meets the condition and/or the timing of the second value meets the condition; and
deriving the first response having the second value and/or indicating the condition has been met if the condition is met.

10. The method according to claim 1, wherein:
the first request is a conditional observe request configured to observe whether at least one resource of the node meets a condition; and
processing said first request comprises:
transmitting a sixth request, said sixth request being an observe request configured to request a value for a resource of a node if the state of the resource of the node changes;
receiving a sixth response from the node, said sixth response comprising the sixth value;
determining whether the sixth value meets the condition;
if the sixth value meets the condition, transmitting the first response to the client, said first response comprising the sixth value and/or indicating the condition has been met.

11. The method according to claim 1, wherein:
the first request is a first discovery request;
processing the first request comprises:
transmitting a second discovery request to the node;
receiving a second discovery response to the second discovery request from the node;
adding the functionality to the second discovery response, by a message rewriter, to derive the first response to indicate said node is configured to support said functionality.

12. The method according to claim 1, further comprising:
intercepting at least one of the following message(s) transmitted from the node:
a third discovery response, said third discovery response transmitted in response to a third discovery request transmitted from the client;
a resource announcement message;
a resource registration message;
adding the functionality to the message, by a message rewriter, to generate a modified message to indicate said node is configured to support said functionality;
transmitting the modified message to the client and/or transmitting the modified message to a resource directory.

13. The method according to claim 1, wherein determining whether the first request is associated with the functionality to be emulated by the intermediary node comprises:
(1) transmitting the first request to the node and receiving a response from the node that the first request is not supported by the node and/or that an error has occurred; or
(2) transmitting a seventh request to retrieve resource(s) and/or capability(-ies) supported by the node, receiving a seventh response in response to the seventh request, and determining whether the first request is supported by the node from the seventh response.

14. The method according to claim 1, wherein determining whether the first request is associated with the functionality to be emulated by the intermediary node comprises:
determining, from a storage of functionalities that the intermediary node is configured to emulate for the node, whether the first request is associated with any of the functionalities in the storage, said storage being at the intermediary node and/or communicably connected to the intermediary node.

15. The method according to claim 1, wherein the node comprises a constrained device, and optionally, the node is communicably connected to the intermediary node over a low power and lossy network.

16. An intermediary node for emulating a functionality for a node, said intermediary node communicably connected to a network, the intermediary node comprising:
a receiver configured to intercept, a first request transmitted over the network from a client;
a functionality emulator configured to:
determine whether the first request is associated with the functionality to be emulated by the intermediary node for the node;
if the first request is associated with the functionality to be emulated by the intermediary node:
process said first request at the intermediary node on behalf of the node in accordance with said functionality to derive a first response; and
a transmitter configured to transmit said first response to the client over the network;
optionally, the intermediary node is configured to implement claim 2.

17. The intermediary node according to claim 16, wherein the node is part of a network of nodes and the intermediary node is located at an edge of the network of nodes.

18. A system comprising at least one node, and an intermediary node of claim 16, said intermediary node communicably connected to the at least one node.

19. The system of claim 18, further comprising a client configured to transmit the first request.

20. A computer program product, implemented on computer-readable non-transitory storage medium, the computer program product configured for, when run on a computer, executing the method steps according to claim 1.
